(19) United States
(12) Patent Application Publication
(10) Pub. No.: US 2003/0024393 A1
(43) Pub. Date: Feb. 6, 2003

(54) Particulate filtering method and device using the same

(76) Inventor: In Gweon Lim, Kyonggi-do (KR)

Correspondence Address: James A. Flight, MARSHALL, GERSTEIN & BORUN, 6300 Sears Tower, 233 South Wacker Drive, Chicago, IL, 60606-6402, US

(21) Appl. No.: 10/201,471

(22) Filed: Jul. 23, 2002

Related U.S. Application Data
(63) Continuation of application No. PCT/KR01/00112, filed on Jan. 26, 2001.

(30) Foreign Application Priority Data
Jan. 26, 2000 (KR) 2000-3814

(51) Int. Cl. B01D 46/30

(52) U.S. Cl. 95/274; 95/283; 55/512; 55/490.1

(57) ABSTRACT

Disclosed is a device and method for filter particulates contained in exhaust gas exhausted from a combustor in an effective manner. The particulate filtering device includes: a filter part disposed on a predetermined position of an exhaust passage to which particulates produced from a combustor are exhausted and having a predetermined volume in which the particulates are filtered; and a support part with which the filter may be of a predetermined shape.

### TECHNICAL FIELD

The present invention relates to a method for filter particulates produced from a combustor inclusive of a diesel engine in an effective manner and a particulate filtering device using the same.

The present invention relates to an improvement of Korea Patent Application No. 10-1999-0044185 (entitled “particulate reducing method and device using the same”) filed by the same applicant as in this invention.

### BACKGROUND ART

Recently, a diesel engine that exhibits a high thermal efficiency is relatively widely used when compared with a gasoline engine. By the way, the particulates exhausted from the diesel engine cause serious environmental pollution. The particulates are exhausted from the diesel engine at the time when air supplied to the engine is small to such an amount as to permit the fuel components injected from a nozzle mounted on the diesel engine not to be fully burnt, or at the time when the fuel components and the air are not well mixed. In order to basically reduce an amount of generation of particulates, therefore, various studies for improving high-pressure injection of fuel, engine conversion and combustion type have been made.

In order to prevent the particulates that have been already produced from being exhausted to the outside, on the other hand, there is provided a conventional method and device wherein the particulate filtering device is disposed on an exhaust passage for the purpose of filtering and treating the particulates before flowing to the outside. The particulate filtering devices conventionally developed until now generally use a ceramic filter or a metal fiber filter. That is to say, the ceramic filter is inserted into the exhaust passage in order to filter the particulates, and if a pressure difference after a predetermined period of time elapses is over a predetermined value, an electric heater or burner operates so that the particulates filtered in the ceramic filter are burnt, thereby reproducing the ceramic filter. In addition, there are developed a method for burning particulates, using a high-voltage plasma and a device for reducing the particulates, using a catalyst. Various kinds of the particulate filtering devices using the ceramic filter are disclosed in U.S. Pat. Ser. Nos. 4,264,346, 4,329,162, 4,662,911, 4,451,441, 5,497,620 and 4,852,349.

However, the conventionally developed particulate filtering devices and methods using the ceramic filter are suffered from the following problems:

Firstly, most of the pore sizes of the ceramic filter are rough 10 μm or less, and the ceramic filter has a thickness in a range of about 1 mm to 5 mm. Such the ceramic filter employs a surface filtration method wherein the filtration is carried out on the surface of the filter. Therefore, the ceramic filter exhibits a high filtration efficiency in an initial step and small volume and size. As the filtration is carried out, however, the size of the passage that can pass through the filter becomes smaller, such that a pressure applied to the filter is drastically increased. If the pressure value is over a predetermined value after a predetermined period of time elapses, the filtered particulates should be burnt by using the electric filter or burner, thereby enabling the ceramic filter to be reproduced.

Secondly, in case of reproducing the ceramic filter, the cracks on the filter may be formed by a serious temperature difference between an exposed portion directly to a high temperature portion of the electric heater or the flame of the burner and an unexposed portion thereof. In order to completely reproduce the ceramic filter, the whole of the ceramic filter should be raised up to an extremely high temperature. In this case, however, there are disadvantages that it is difficult to heat the ceramic filter in a uniform level and a great large amount of electric capacity should be required. In case of burning the filtered particulates, moreover, generation of undesired nitrogen oxide may be caused.

Thirdly, in case where the ceramic filter is not completely reproduced, the passage of the ceramic filter is blocked by substantially minute particulates produced at the time of the reproduction, with a result that overload will be applied to the exhaust passage. Thus, the ceramic filter becomes cracked or broken. As a result, the particulate filtering device can't filter a smaller amount of particulates than that really expected. This causes the reproduction of the ceramic filter to be carried out very often, thereby making it difficult to achieve an effective operation of the particulate filtering device.

Finally, the electric heater or burner should be provided for the purpose of reproducing the ceramic filter, such that the device is constructed in more complicated manner and the life thereof is not long.

### DISCLOSURE OF INVENTION

It is an object of the present invention to provide a particulate filtering device and method wherein particulates can be effectively filtered and the use thereof is possible for a long period of time, without any reproduction.

According to an aspect of the present invention, there is provided a particulate filtering device that includes: a filter part disposed on a predetermined position of an exhaust passage to which particulates produced from a combustor are exhausted and having a predetermined volume in which the particulates are filtered; and a support part with which the filter part may be in a predetermined shape.

The filter part is of filter media of a pore type, which are preferably composed of a plurality of generally circular or oval balls. The filter media are desirably formed of at least one combination of ceramic, metal or sand. The ball is coated with a catalyst on the surface thereof, for the purpose of filtering the particulates and at the same time treating other pollution materials exhausted.

Preferably, on the other hand, the balls have a mean diameter in a range of 100 μm to 1500 μm, and the rate of volume and inlet surface area of the filter part is 20 mm or more, or the mean pore percentage of the filter part is in a range of 25% to 40%. The filter media are composed of the plurality of balls having different sizes from each other within a prescribed range.

According to another embodiment of the present invention, there is provided a particulate filtering device having a filter part being composed of a combination of a plurality of filter media having different sized-balls.

At this time, the pore percentage is desirably decreased step by step from the filter media at the front stage toward the filter media at the rear stage. Also, the sizes of the balls are desirably reduced step by step from the filter media at the front stage toward the filter media at the rear stage.

According to yet another embodiment of the present invention, there is provided a particulate filtering device disposed at a predetermined position on an exhaust passage in such a manner as to be attachable and detachable.

In the preferred embodiments of the present invention, the filter part further includes a plurality of heating wires for carrying out combustion for the particulates filtered in the interior of the filter part.

According to another aspect of the present invention, there is provided a particulate filtering method including the steps of: filtering particulates in a predetermined volume to which filter media of a pore type are collected to thereby form a filtration layer; and passing exhaust gas through the filtration layer. At this time, the particulate filtering method further includes the step of carrying out heating for the filtration layer to thereby reproduce the filtration layer.

### BRIEF DESCRIPTION OF THE DRAWINGS

Further objects and advantages of the invention can be more fully understood from the following detailed description taken in conjunction with the accompanying drawings, in which:

FIG. 1 is a schematically sectional view of a particulate filtering device according to a first embodiment of the present invention;

FIG. 2 is a modified embodiment of FIG. 1;

FIG. 3 is a schematically sectional view of a particulate filtering device according to a second embodiment of the present invention;

FIG. 4 is a schematically sectional view of a particulate filtering device according to a third embodiment of the present invention;

FIG. 5 is a detailed perspective view of FIG. 4;

FIG. 6 is a modified embodiment of FIG. 5;

FIG. 7 is a schematically sectional view of a particulate filtering device according to a fourth embodiment of the present invention;

FIGS. 8 and 9 are graphs illustrating the performance of the particulate filtering devices of the present invention;

FIG. 10 is a graph illustrating the filtration efficiency, in case of a single-stage filter part; and

FIG. 11 is a graph illustrating the filtration efficiency, in case of a multistage filter part.

### BEST MODE FOR CARRYING OUT THE INVENTION

Hereinafter, preferred embodiments of the present invention will be discussed with reference to the accompanying drawings.

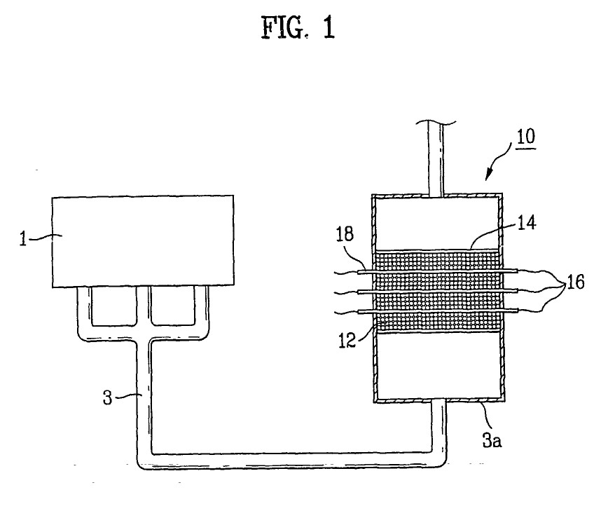

Referring first to FIG. 1, an explanation of the overall construction of the particulate filtering device according to a first preferred embodiment of the present invention will be given.

A combustor 1 that produces exhaust gas is connected to an exhaust passage 3 that exhausts the exhaust gas to the outside. And, a particulate filtering device 10 is disposed at a predetermined position on the exhaust passage 3, for the purpose of filtering the particulates contained in the exhaust gas. Preferably, the portion 3a on the exhaust passage 3 where the particulate filtering device 10 is disposed has a greater passage size than other portions thereon. In addition, the particulate filtering device 10 is directly disposed on a muffler (which is omitted in the drawing).

The particulate filtering device 10 is composed of a filter part 12 for filtering the particulates and a support part 14 for accommodating and supporting the filter part 12. In this case, the filter part 12 has a prescribed volume, in which the particulates are filtered. In other words, the filter part 12 is comprised of filter media of a pore type. And, the support part 14 takes the shape of a mesh, such that it receives the filter media of the pore type, maintains a predetermined shape of the filter part 12 and enables flowing to be passed. In the interior of the filter media, there is provided a plurality of heating wires 16 that are heated by the electricity supplied. It is desirable that each of the heating wires is surrounded with a protective tube 18 made of a ceramic or metal material, for the purpose of preventing each heating wire 16 from being in direct contact with the balls.

The filter media of the pore type are formed by arrangement of a plurality of balls, each of which is made of a ceramic or metal material. The size of each ball is determined in accordance with the sizes and amount of particulates filterable.

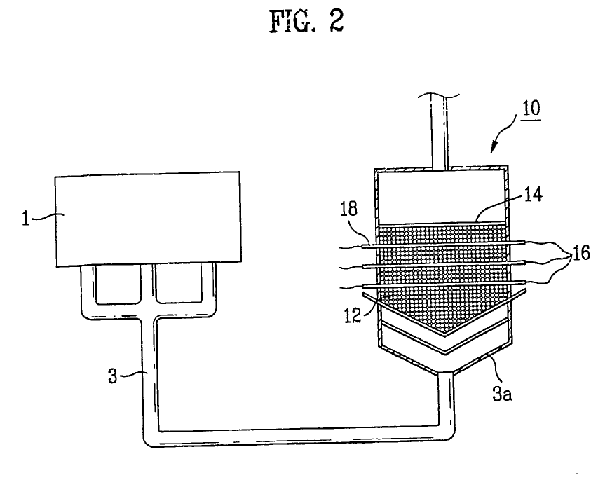

As shown in FIG. 2, the whole shape of the particulate filtering device 10 according to the first embodiment of the present invention is not restricted to a generally cylindrical shape, but may be in various shapes. This is because the filter part 12 of the present invention is composed of the filter media of the pore type, which does not give any influence in the shape thereof. The whole shape of the particulate filtering device 10 is determined upon the shape of the support part 14.

In operation, the exhaust gas produced from the combustor 1 is exhausted to the exhaust passage 3, and the exhaust gas flowing to the exhaust passage 3 is passed through the particulate filtering device 10. The exhaust gas is passed through one side of the support part 14 and then passed through the filter part 12 composed of the plurality of balls. At this time, the particulates contained in the exhaust gas are filtered in the whole volume of the filter part 12, and others are exhausted to the outside of the particulate filtering device 10 via the other side of the support part 14. On the other hand, when the particulates are continuously filtered, the pressure of the exhaust gas is increased, and if the pressure value of the exhaust gas is over a predetermined pressure value, electricity is supplied to the heating wires 16. Thereby, the heating wires 16, the corresponding protective tubes 18 and the filter media are sequentially heated, thereby raising their temperatures. As the temperatures are raised, the particulates filtered are burnt.

On the other hand, the preferred embodiment of the present invention describes the ball that is made of the ceramic or metal material, but for example, it may be made of other materials. In other words, the ball may be formed of ceramic, metal or sand, or formed of a combination of them. The ball is coated with a catalyst on the surface thereof, for the purpose of filtering the particulates and at the same time treating other pollution materials exhausted.

In case where the particulates are filtered by the diffusion and inertial collision against each other, the filtration efficiency is influenced by the sizes of the balls as the filter media and rarely influenced by the material of the ball. In case of the ceramic ball, however, it is likely to be cracked by external shocks or drastic temperature variations, such that small pieces produced from the cracks of each ball undesirably block the interior of the filter part 12. Therefore, the metal ball is more desirable than the ceramic ball. The metal material may be used with Fe. This is because stable oxidized steel is formed on a surface layer of the steel ball by fine carbon particles and oxygen contained in the exhaust gas. Therefore, a low-priced Fe ball that can remove cracks and corrosion is desirably used.

In case where the distribution of the sizes of the balls constructing the filter media becomes greater, that is, in case where the balls have substantially different sizes from each other, the filtration efficiency becomes increased. It is therefore desirable that the balls having the substantially different sizes are mixed and arranged. In this case, the ceramic or metal balls that are processed in various sizes can be used, but sand can be preferably arranged. This is because the sand exhibits a large distribution of the particle sizes even in an untreated state and is immediately available, without any separate processing treatment. Also, in case of using the metal balls, sintering is not avoided at the time when beat is applied to the balls in order to carry out the combustion for the particulates filtered, with a result that the metal balls are adhered to each other. In case of using the sand, however, the sintering can be basically prevented. Moreover, in case of applying the heat with the electric heater, the sand exhibits a considerably low thermal conductivity than the metal balls, such that the temperature is raised around the heater, thereby ensuring that the combustion is easily carried out.

On the other hand, each of the balls is of a generally circular or oval shape, but may be of an appropriately sized-shape having a predetermined pore percentage when the balls are collected. Also, the ball may form a plurality of concaves/convexes on the surfaces thereof.

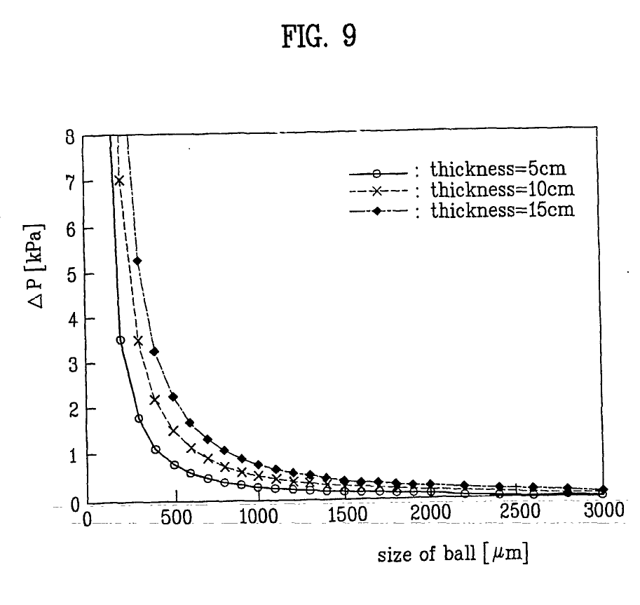

An appropriate size of each of the balls is determined in terms of the filtration efficiency and pressure loss of the particulate filtering device 10. FIGS. 8 and 9 are graphs illustrating the performance of the particulate filtering device 10 of the present invention. In these experiments, it is assumed that displacement of diesel engine is 4000 cc, revolutions per minute is 2500 rpm, exhaust gas temperature is 450 K and the size of the particulate is 1 μm or less. Under the above conditions, the results for the filtration efficiency and the pressure loss of the particulate filtering device 10 according to the size of the ball and the thickness of the device are obtained. From the results, it can be noted that in case where the filtration efficiency is about 70% or more and the pressure loss is about 3 kPa or less, the particulate filtering device 10 exhibits good performance. When it is assumed that the volume of the filter part 12 is V and the inlet surface area thereof is A, desirably, a mean thickness V/A of the filter part 12 is 20 mm or more and a mean diameter of the balls is in a range of 100 μm to 1500 μm. Further, a mean pore percentage of the filter part 12 is desirably in a range of 25% to 40%. As noted above, it is therefore desirable that the balls having the substantially different sizes within a predetermined range are mixed and arranged.

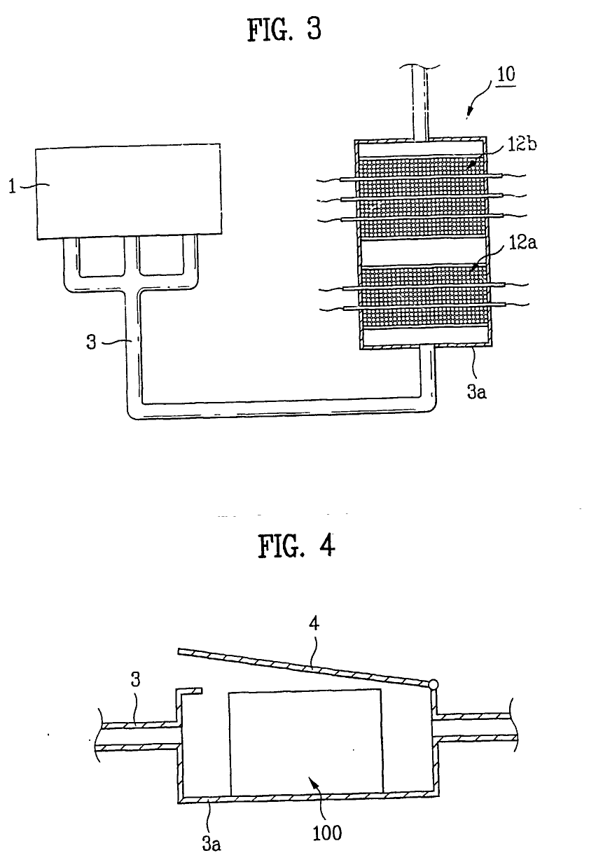

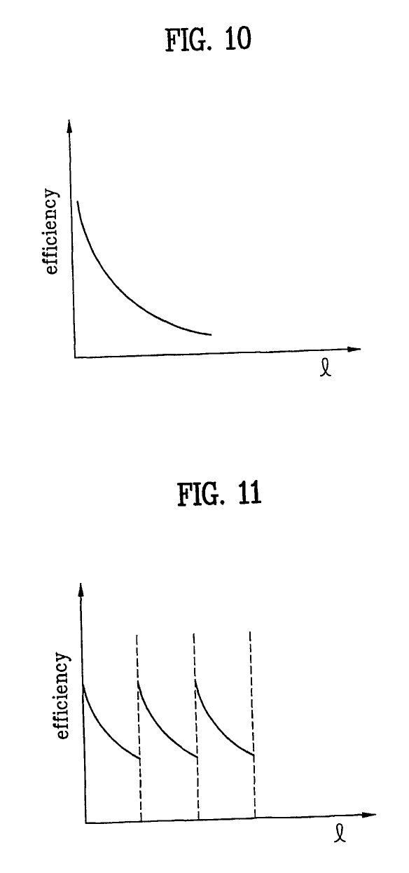

As shown in FIG. 3, on the other hand, the filter media are preferably disposed in multistage 12a and 12b manner. This is because an amount of filtration per unit length of the filter part 12 is dimensionally inversely proportional to the size of the ball and contrarily, the pressure loss thereof is proportional to the square of the amount of filtration. That is to say, as shown in FIG. 10 in case where the particulates are filtered by using the single-stage filter media, the particulates filtered are almost distributed on the inlet portions of the filter media, thereby evoking an excessive pressure loss. If an increase in the pressure loss is to be minimized, it is preferable that the particulates are evenly filtered on the whole of the filter media. To this end, the filter media should be arranged in the multistage 12a and 12b manner. More desirably, the sizes of the balls contained in each of the filter media are decreased step by step from the exhaust gas absorbing direction toward the exhaust gas exhausting direction. The balls contained in each of the filter media may be made of different materials from each other, or the filter media on each stage have different thickness from each other, such that the sizes and amount of particulates filterable can be adjusted.

As mentioned above, if the sizes of the balls are decreased step by step, the variations of the amount of filtration according to transmission length and the sizes of the balls are offset by each other. As shown in FIG. 11, on the front stage of the filter media where the sizes of the balls are great, the filtration efficiency is low, but the pressure loss is low. To the contrary, on the rear stage of the filter media where the sizes of the balls are small, the filtration efficiency is high, but the pressure loss is high. Therefore, the filter part 12 exhibits an even distribution of the amount of particulates filtered therein and an excellent pressure loss.

On the other hand, the particulates contained in a high-temperature exhaust gas produced from the combustor 1 exhibit a high attaching effect (that is, thermophoresis) as the balls as the filter media have a low temperature and the temperature difference between the particulates and the balls is great. Therefore, the particulates are collected and attached around the inlet portion of the filter part 12, until the temperature of the particulate filtering device 10 is equal to that of the exhaust gas after the combustor 1 starts initially, such that a pressure increase appears drastically. At this time, such the pressure increase should be of course avoided. To this end, it is desirable that the filter part 12 should be of the multistage filter media 12a and 12b. In other words, the filter media on the front stage 12a are composed of large-sized balls having a relatively low filtration efficiency and those on the rear stage 12b are composed of small-sized balls, thereby effectively preventing the undesired pressure increase.

Referring to FIG. 4, an explanation of the particulate filtering device according to a third preferred embodiment of the present invention will be described.

In the third embodiment of the present invention, the operation principles thereof are the same as in the above-mentioned first and second embodiments. However, in the third embodiment of the present invention the particulate filtering device 100 is disposed at a predetermined position on the exhaust passage 3 in such a manner as to be attachable and detachable. As a result, the particulate filtering device 100 can be used for a long period of time, without any reproduction and also manufactured at a relatively low production cost. In more detail, the particulate filtering device 100 of the present invention can prevent a drastic pressure increase, so that it can filter the particulates for a long period of time. According to the third embodiment of the present invention, hence, the filter is designed and manufactured in such a manner that it can be exchanged and recycled, without any reproduction.

As shown, a cover 4, which is capable of opening and closing, is disposed on the exhaust passage 3, and using the cover 4, the particulate filtering device 100 can be attachable and detachable. However, the above-described construction may be modified within the technical spirit of the present invention. The method of installing the particulate filtering device 100 in the attachable and detachable manner is obvious to those skilled in the art and therefore, an explanation of it will be avoided.

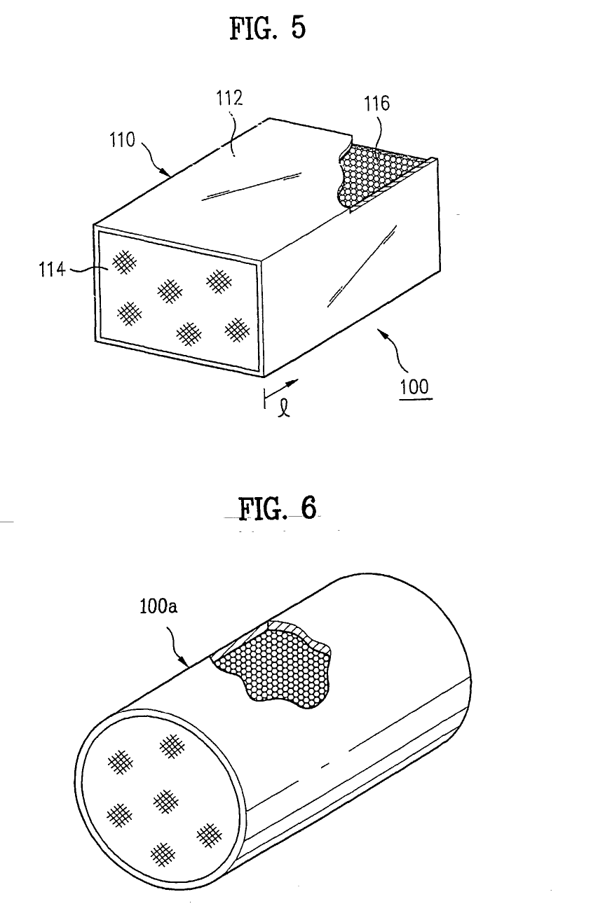

Referring to FIG. 5, an explanation of the particulate filtering device 100 disposed in the attachable and detachable manner will be in detail described.

In similar manner to the above-mentioned embodiments, the particulate filtering device 100 is composed of a filter part 116 having a predetermined volume and including filter media of a pore type, and a support part 110 for protecting and supporting the filter media of the pore type. The support part 110 is in the shape of a mesh on the front and back surfaces 114, such that the exhaust gas can flow therein and therefrom. The side 112 thereof is sealed. Of course, since the particulate filtering device 100 is disposed at the predetermined position on the exhaust passage 3, the side 112 of the support part 100 may be in the mesh shape.

On the other hand, FIG. 6 shows a substantially cylindrical particulate filtering device 100a. As noted above, the shape of the particulate filtering device can be freely made to some desired other shape in conformity with the shape of the support part 110.

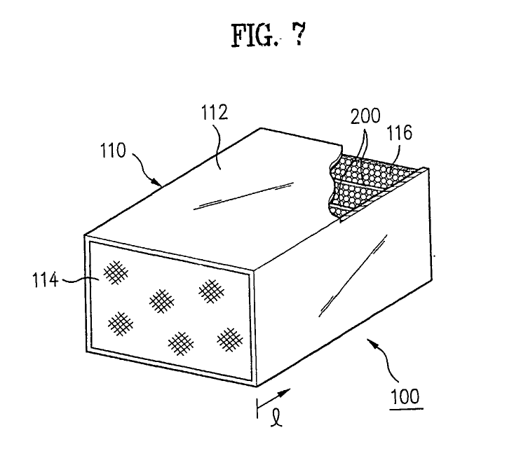

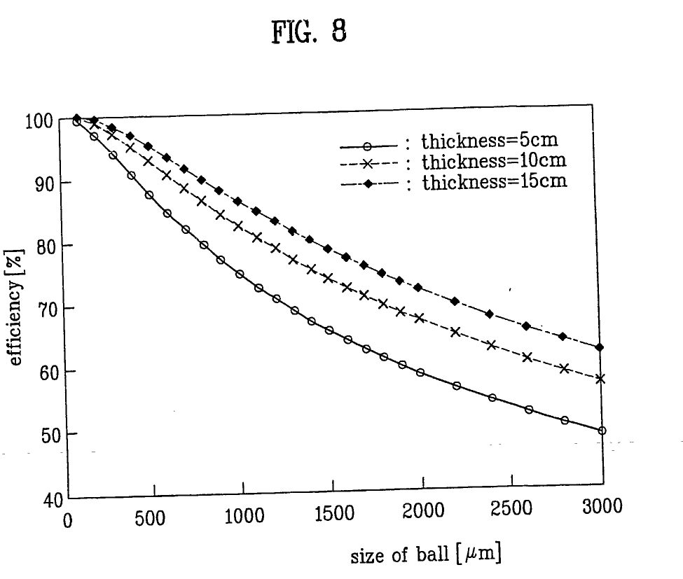

Also, as shown in FIG. 7, a plurality of bulkheads 200 being in the shape of a mesh are disposed in spaced relation to each other in the interior of the support part 110, thereby providing the multistage filter media.

The operation principles of the device according to the fourth embodiment of the present invention are the same as those according to the above-mentioned embodiments of the present invention, an explanation of which will be omitted for a brief description of the present invention.

### INDUSTRIAL APPLICABILITY

As set forth in the foregoing, a particulate filtering device according to the preferred embodiments of the present invention has the following advantages:

Firstly, the device of the present invention can prevent a drastic pressure increase suffered in general particulate filtering devices, such that the particulate filtration can be carried out for a long period of time. The filter is designed and manufactured in such a manner that it can be exchanged and recycled, without any reproduction.

Secondly, there is no need for installation of a reproducing device and a reproduction control device, such that the device of the present invention requires low installation and maintenance cost and exhibits high reliability.

Thirdly, the device of the present invention uses filter media of a pore type, such that the shape thereof is freely designed. 0Further, the sizes and arrangement of the filter media of the pore type used are properly adjusted, thereby setting an amount of particulates filtered and a position of the filtration.

Finally, the device of the present invention removes the cracks of a ceramic filter due to uneven heating experienced in the general particulate reducing device, such that there is no need for installation of an auxiliary device such as an auxiliary combustor.

What is claimed is:

1. A particulate filtering device comprising:
a filter part disposed at a predetermined position on an exhaust passage to which particulates produced from a combustor are exhausted and having a predetermined volume in which the particulates are filtered; and
a support part for supporting the filter part, such that the filter part may be in a predetermined shape.

2. The particulate filtering device according to claim 1, wherein the filter part is filter media of a pore type.

3. The particulate filtering device according to claim 2, wherein the filter media are composed of a plurality of generally circular or oval balls.

4. The particulate filtering device according to claim 3, wherein the filter media are formed of at least one combination of ceramic, metal and sand.

5. The particulate filtering device according to claim 4, wherein each of the balls is coated with a catalyst on the surface thereof, for the purpose of filtering the particulates and at the same time treating other pollution materials exhausted.

6. The particulate filtering device according to any of claims 2 to 5, wherein each of the balls has a mean diameter in a range of 100 μm to 1500 μm, and the rate of volume and inlet surface area of the filter part is 20 mm or more.

7. The particulate filtering device according to any of claims 2 to 5, wherein the filter part has a mean pore percentage in a range of 25% to 40%.

8. The particulate filtering device according to any of claims 2 to 5, wherein the filter media are composed of the plurality of balls having different sizes from each other within a prescribed range.

9. The particulate filtering device according to any of claims 2 to 5, wherein the filter part is composed of a combination of a plurality of filter media having different sized-balls.

10. The particulate filtering device according to claim 9, wherein the pore percentage of the filter media is decreased step by step from the filter media at the front stage toward the filter media at the rear stage.

11. The particulate filtering device according to claim 10, wherein the size of each of the balls is reduced step by step from the filter media at the front stage toward the filter media at the rear stage.

12. The particulate filtering device according to any of claims 2 to 5, wherein the particulate filtering device is disposed at a predetermined position on an exhaust passage in such a manner as to be attachable and detachable.

13. The particulate filtering device according to any of claims 2 to 5, wherein the filter part further comprises a plurality of heating wires.

14. The particulate filtering device according to claim 13, wherein each of the plurality of heating wires is provided with a protective tube on the external surface thereof.

15. The particulate filtering method comprising the steps of:
filtering particulates in a predetermined volume to which filter media of a pore type are collected to thereby form a filtration layer; and
passing exhaust gas through the filtration layer.

16. The particulate filtering method according to claim 15, further comprising the step of carrying out heating for the filtration layer to thereby reproduce the filtration layer.
